(19) United States
(12) Patent Application Publication
(10) Pub. No.: US 2013/0155680 A1
(43) Pub. Date: Jun. 20, 2013

(54) Low Form Factor Synthetic Jet Thermal Management System

(71) Applicants: Daniel N. Grimm, Round Rock, TX (US); Stephen P. Darbin, Austin, TX (US)

(72) Inventors: Daniel N. Grimm, Round Rock, TX (US); Stephen P. Darbin, Austin, TX (US)

(73) Assignee: NUVENTIX, INC., Austin, TX (US)

(21) Appl. No.: 13/704,549

(22) PCT Filed: Jun. 17, 2011
(86) PCT No.: PCT/US11/40794

§ 371 Date: Jan. 16, 2013

Related U.S. Application Data
(60) Provisional application No. 61/355,308, filed on Jun. 16, 2010.

(51) Int. Cl. F21V 29/00

(52) U.S. Cl. CPC F21V 29/2206
USPC 362/249.02; 362/373

(57) ABSTRACT

A combination of a synthetic jet ejector with a host device is provided. The combination comprises (a) a chamber having an aperture disposed in a wall thereof; (b) a diaphragm disposed in said chamber; and (c) an actuator adapted to vibrate said diaphragm so as to create a synthetic jet in a flow of fluid exiting said chamber through said aperture; wherein said chamber has at least one interior surface which is formed by an element of the host device.

### CROSS-REFERENCE TO RELATED APPLICATION

This application is a continuation of International Application Number PCT/US2011/40794, filed Jun. 17, 2011, having the same title, and having the same inventors, and which is incorporated herein in its entirety; which application claims the benefit of U.S. Provisional Application No. 61/355,308 filed Jun. 16, 2010, having the same title and the same inventors, and which is incorporated herein in its entirety.

### FIELD OF THE DISCLOSURE

The present disclosure relates generally to synthetic jet ejectors, and more particularly to synthetic jet ejectors having a low form factor.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile solution where thermal management is required at the local level. Frequently, synthetic jet ejectors are utilized in conjunction with a conventional fan based system. In such hybrid systems, the fan based system provides a global flow of fluid through the device being cooled, and the synthetic jet ejectors provide localized cooling for hot spots and also augment the global flow of fluid through the device by perturbing boundary layers.

Various examples of synthetic jet ejectors are known to the art. Some examples include those disclosed in U.S. 20070141453 (Mahalingam et al.) entitled “Thermal Management of Batteries using Synthetic Jets”; U.S. 20070127210 (Mahalingam et al.), entitled “Thermal Management System for Distributed Heat Sources”; 20070119575 (Glezer et al.), entitled “Synthetic Jet Heat Pipe Thermal Management System”; 20070119573 (Mahalingam et al.), entitled “Synthetic Jet Ejector for the Thermal Management of PCI Cards”; 20070096118 (Mahalingam et al.), entitled “Synthetic Jet Cooling System for LED Module”; 20070081027 (Beltran et al.), entitled “Acoustic Resonator for Synthetic Jet Generation for Thermal Management”; and 20070023169 (Mahalingam et al.), entitled “Synthetic Jet Ejector for Augmentation of Pumped Liquid Loop Cooling and Enhancement of Pool and Flow Boiling”.

### BRIEF DESCRIPTION OF THE DRAWINGS

FIG. 1 is a schematic illustration of a prior art synthetic jet ejector in a host device.

FIG. 2 is a schematic illustration of a first embodiment of a synthetic jet ejector in a host device in accordance with the teachings herein.

FIG. 3 is a schematic illustration of a second embodiment of a synthetic jet ejector in a host device in accordance with the teachings herein.

FIGS. 4-16 are illustrations of a first embodiment of an illumination device in accordance with the teachings herein.

FIG. 17 is an illustration of a first embodiment of an illumination device in accordance with the teachings herein.

FIG. 18 is a cross-section taken along LINE 18-18 of FIG. 17.

FIG. 19 is an illustration of a first embodiment of an illumination device in accordance with the teachings herein.

FIG. 20 is a cross-section taken along LINE 20-20 of FIG. 17.

### SUMMARY OF THE DISCLOSURE

In one aspect, a combination of a synthetic jet ejector with a host device is provided. The combination comprises (a) a chamber having an aperture disposed in a wall thereof; (b) a diaphragm disposed in said chamber; and (c) an actuator adapted to vibrate said diaphragm so as to create a synthetic jet in a flow of fluid exiting said chamber through said aperture; wherein said chamber has at least one interior surface which is formed by an element of the host device.

In another aspeca, a light source is provided which comprises (a) a housing element; (b) a heat sink; (c) a first flow channel element which, alone or in combination with said housing element, creates (i) a first set of flow paths for the flow of fluid in a first direction through the light source, and (ii) a second set of flow paths for the flow of fluid in a second direction through the light source; (d) an LED which is in thermal contact with said heat sink; and (e) a synthetic jet ejector which comprises a diaphragm disposed in a chamber; wherein said chamber is in fluidic communication with said first set of flow paths, and wherein said chamber has at least one surface formed by at least one of said housing element and said heat sink.

### DETAILED DESCRIPTION

While synthetic jet ejectors have found increasing use as thermal management devices, size limitations have limited their use and effectiveness in several applications. In particular, in some applications, as in certain lighting applications, existing synthetic jet ejectors are found to consume too much space to be accommodated within the frequently tight space constraints of the host device. For example, many common light bulb configurations have profiles whose dimensions are dictated by industry specifications, and hence, illumination devices based on these designs often have little room to accommodate a synthetic jet ejector. This problem is often exacerbated by the design of the synthetic jet ejector, which may not make efficient use of the space available to it in such applications.

It has now been found that the foregoing needs may be met through the provision of a synthetic jet ejector which utilizes one or more walls or surfaces of a host device to form the housing of the synthetic jet ejector. This approach allows the synthetic jet ejector to be made with a smaller form factor than would be the case if a stand-alone synthetic jet ejector were incorporated into the host device. This approach is especially suitable for use in lighting applications as, for example, when a synthetic jet ejector is used to provide thermal management for a light bulb, because it allows the synthetic jet ejector to make efficient use of the (typically limited and often irregularly-shaped) space available within the host device.

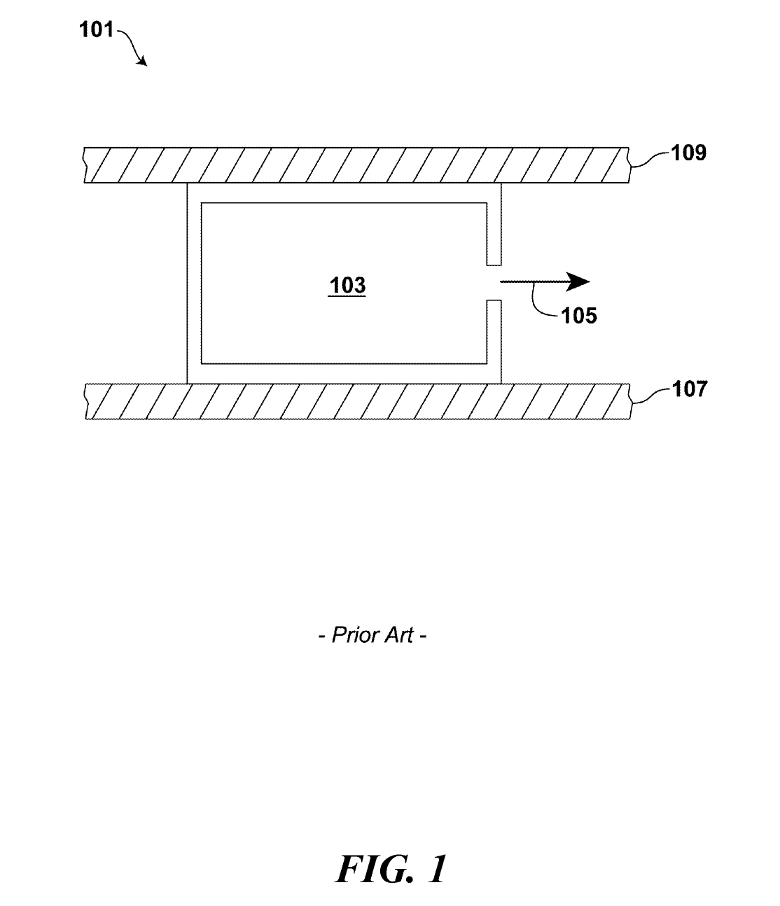

The foregoing principles may be appreciated with reference to FIGS. 1-3. FIG. 1 illustrates a prior art combination 101 of a host device and a synthetic jet ejector 103 which emits one or more synthetic jets 105. The synthetic jet ejector 103 is incorporated into the host device which, in the particular embodiment depicted, has first 107 and second 109 opposing surfaces. As seen therein, the space between the first 107 and second 109 opposing surfaces must be great enough to accommodate the synthetic jet ejector 103, and this space is increased by the thickness of the walls of the synthetic jet ejector 103 which are adjacent to the first 107 and second 109 opposing surfaces.

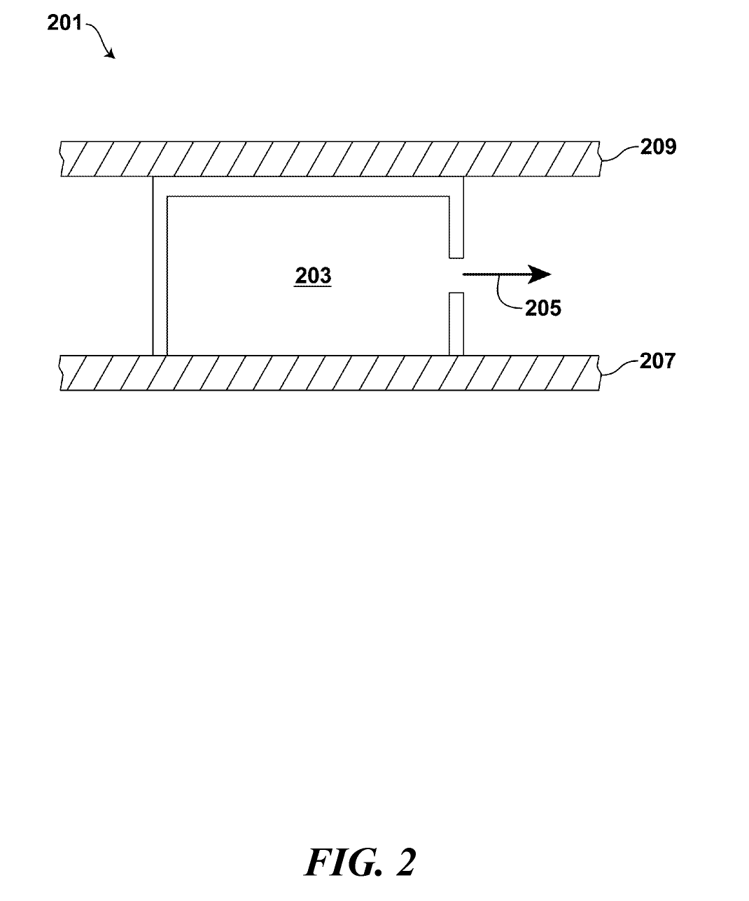

FIG. 2 illustrates a first particular, non-limiting embodiment of a combination 201 in accordance with the teachings herein of a host device and a synthetic jet ejector 203 which emits one or more synthetic jets 205. The synthetic jet ejector 203 is incorporated into the host device which, in the particular embodiment depicted, has first 207 and second 209 opposing surfaces. As seen therein, the space between the first 207 and second 209 opposing surfaces must be great enough to accommodate the synthetic jet ejector 203. However, in the embodiment depicted, this space has been reduced by utilizing the first wall 207 of the host device as one of the walls of the synthetic jet ejector 203.

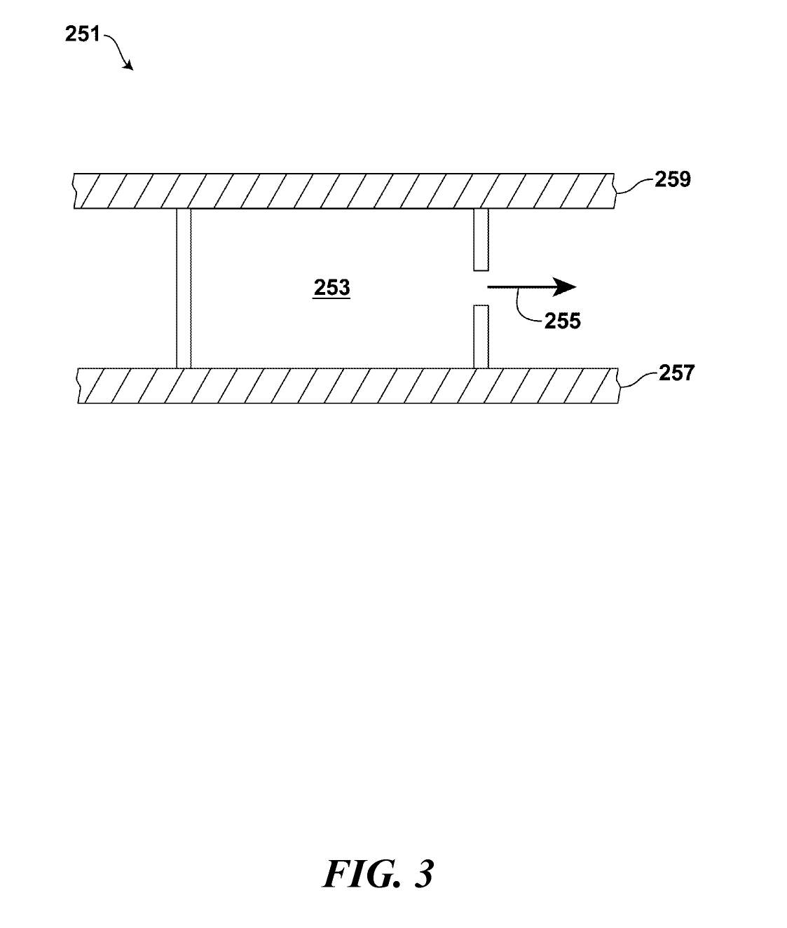

FIG. 3 illustrates a second particular, non-limiting embodiment of a combination 251 in accordance with the teachings herein of a host device and a synthetic jet ejector 253 which emits one or more synthetic jets 255. The synthetic jet ejector 253 is incorporated into the host device which, in the particular embodiment depicted, has first 257 and second 259 opposing surfaces. As seen therein, the space between the first 257 and second 259 opposing surfaces must be great enough to accommodate the synthetic jet ejector 253. However, in the embodiment depicted, this space has been reduced by utilizing both the first wall 257 and the second wall 259 of the host device as walls of the synthetic jet ejector 253.

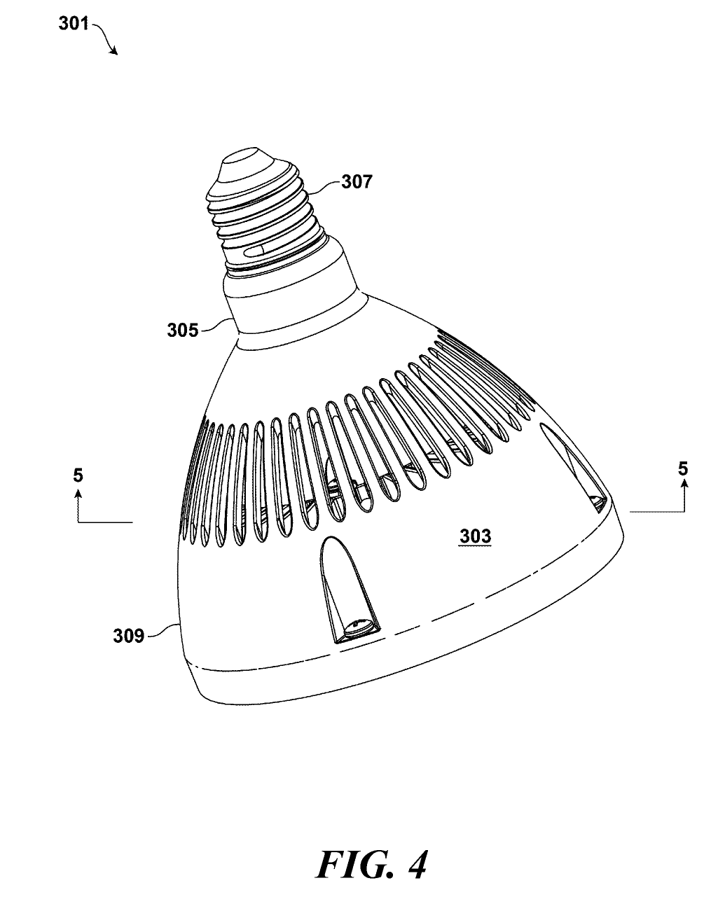

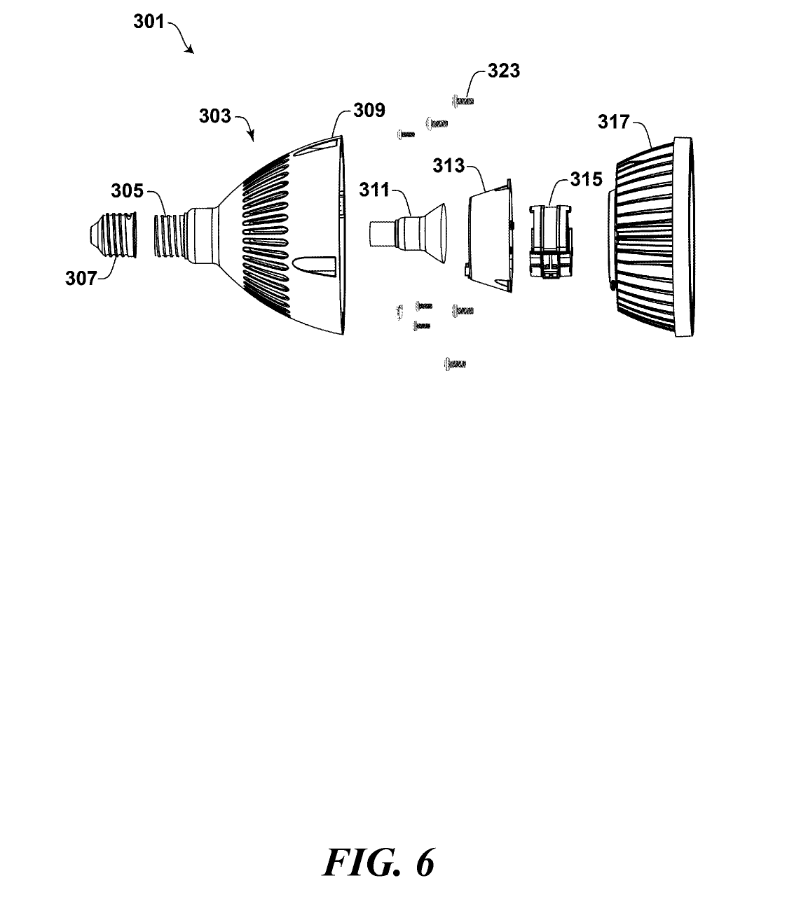

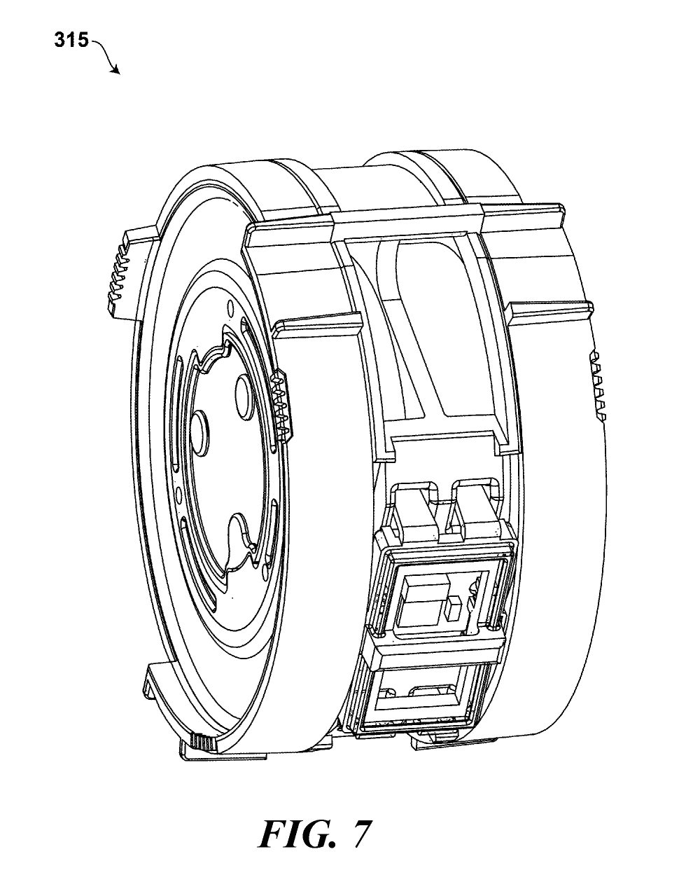

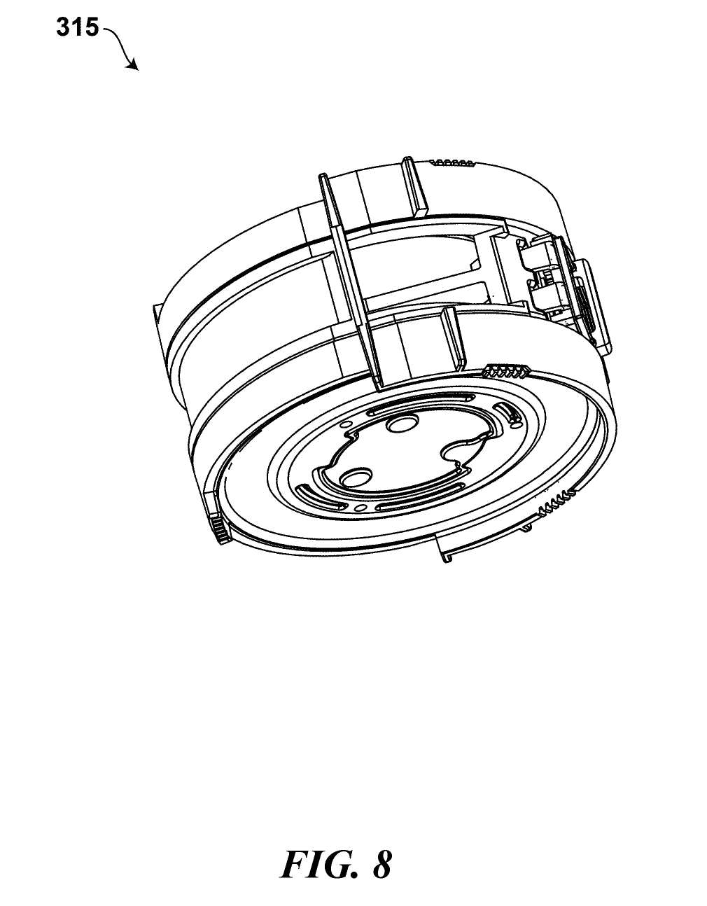

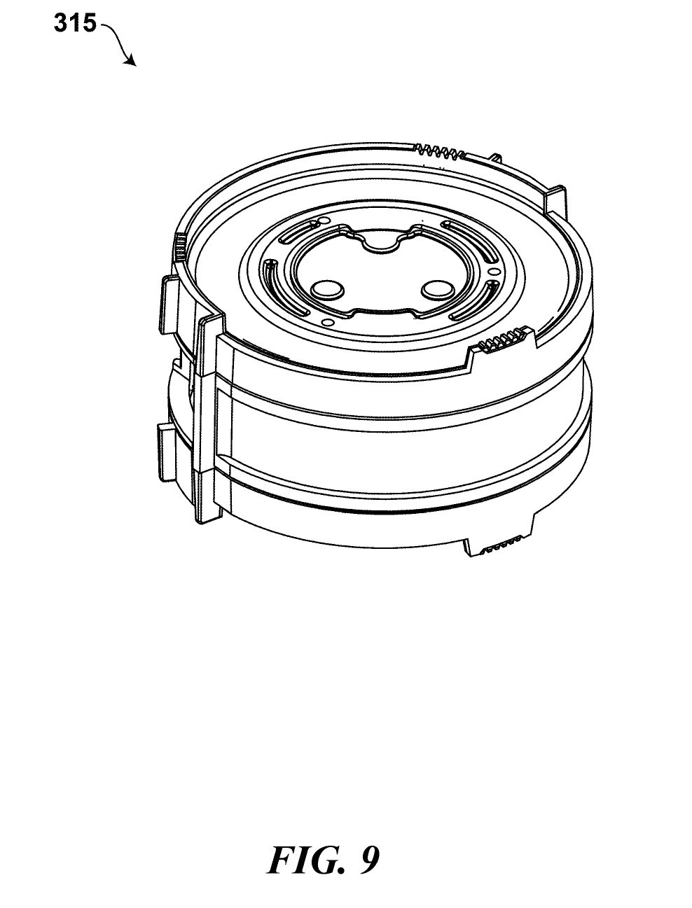

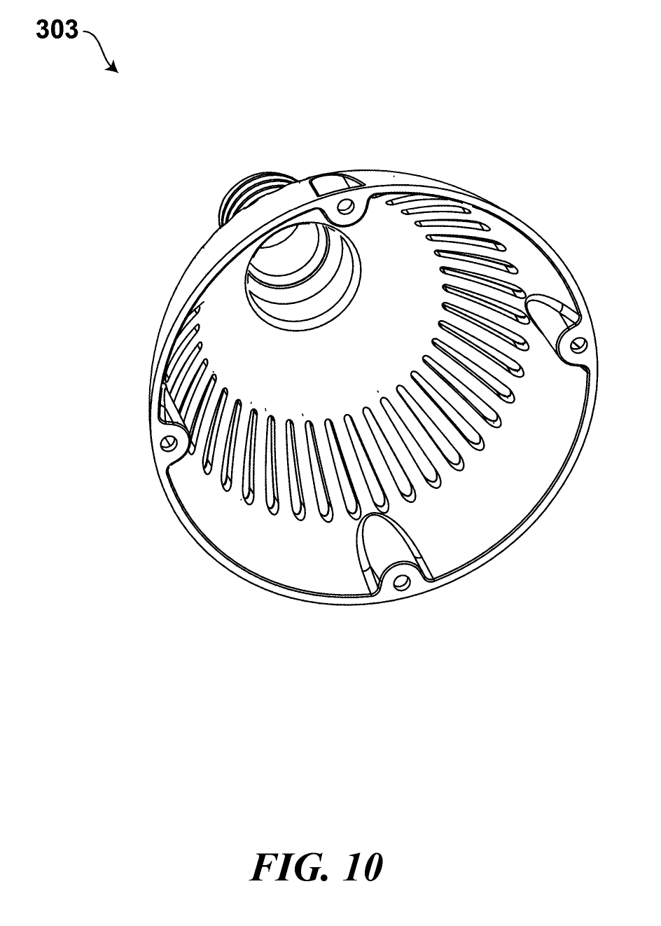

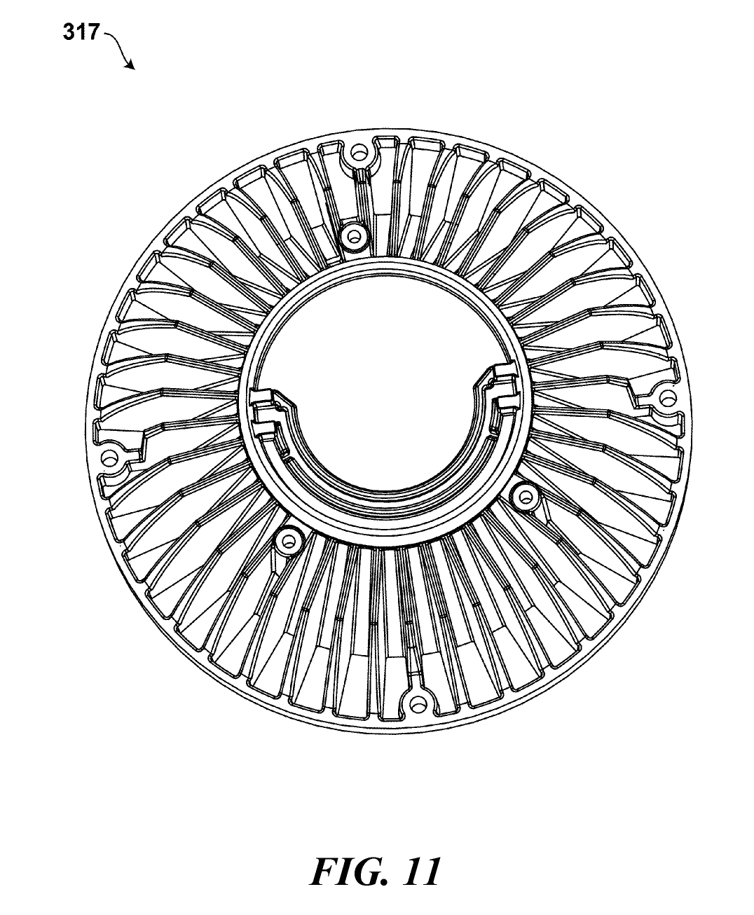

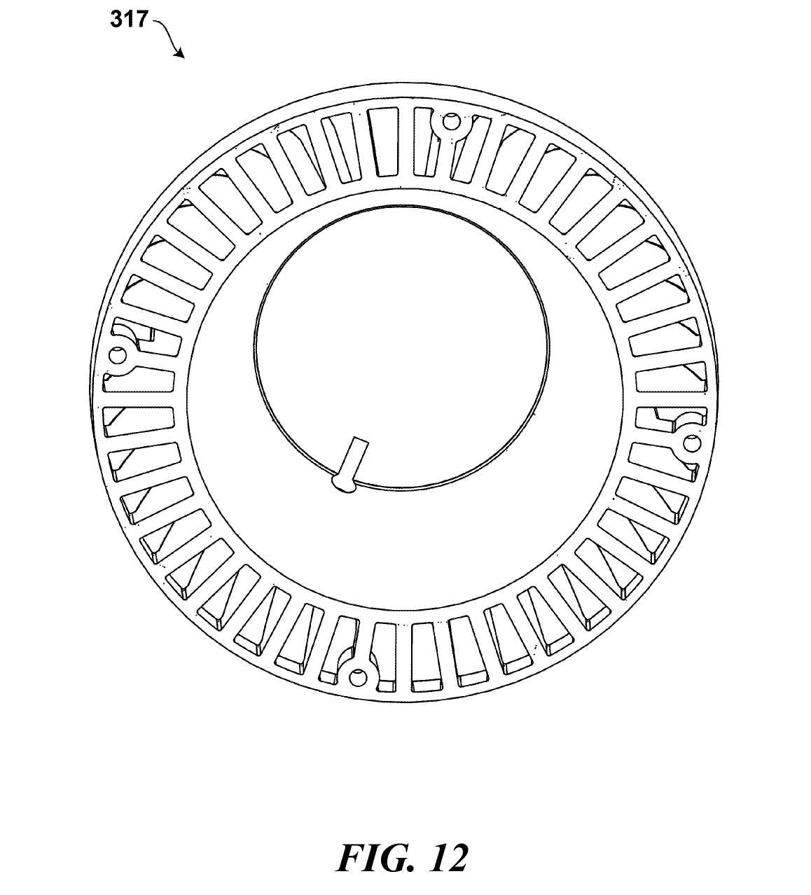

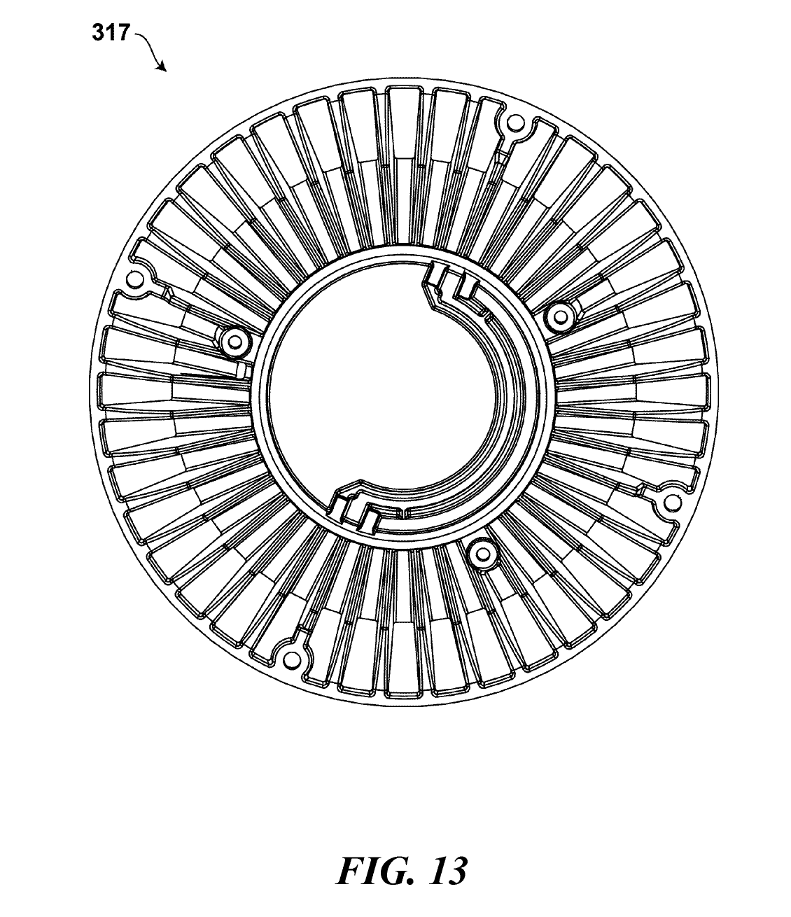

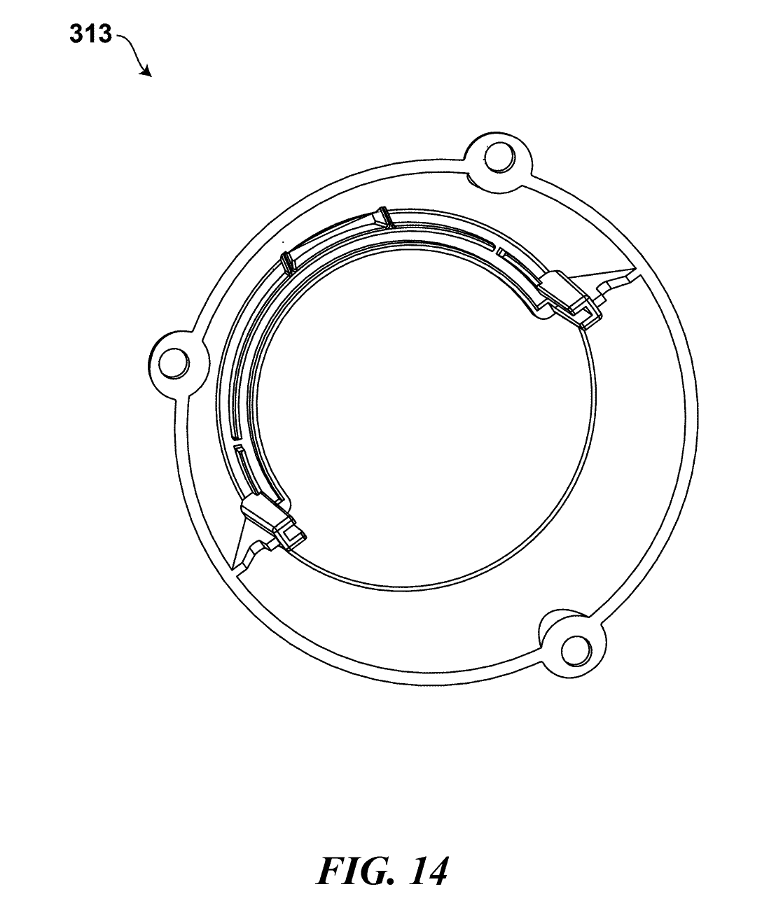

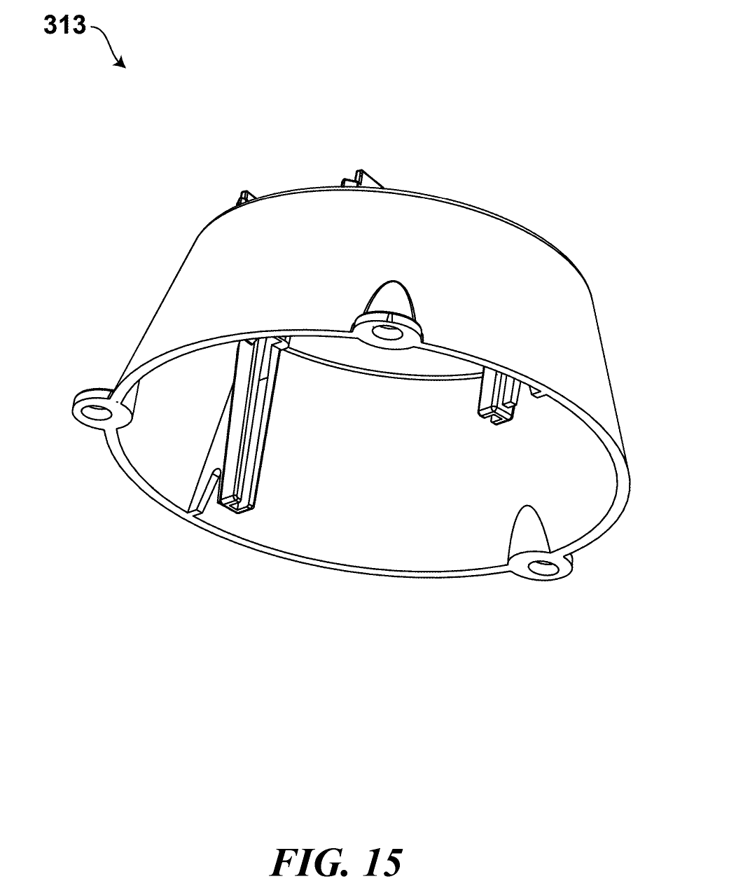

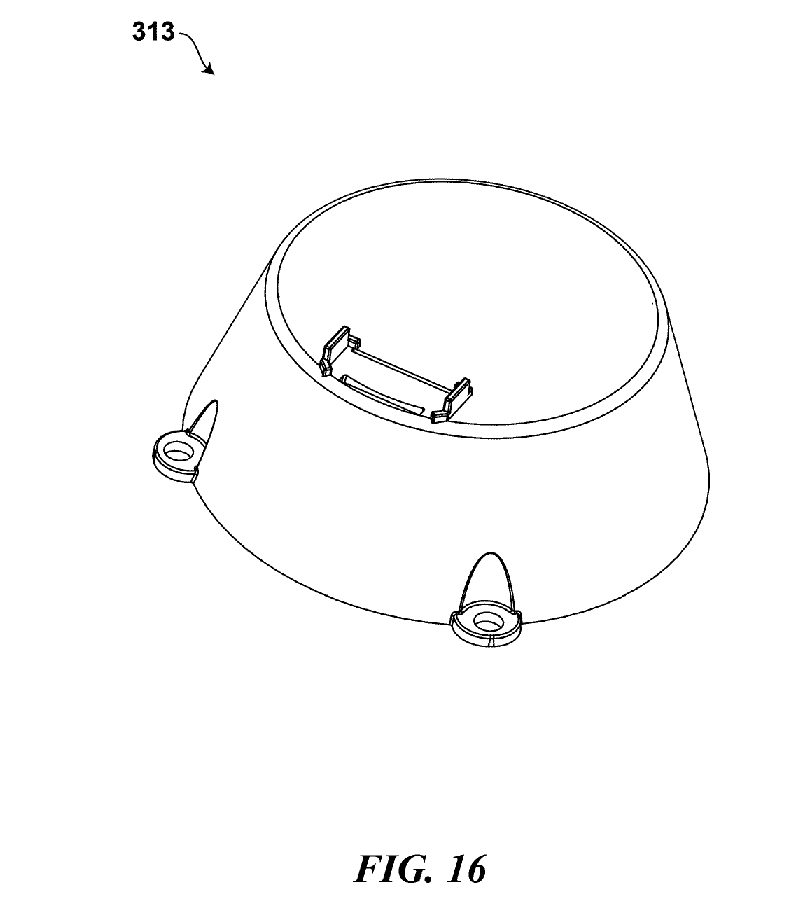

FIGS. 4-16 illustrate a first particular, non-limiting embodiment of an illumination device made in accordance with the teachings herein. In the particular embodiment depicted, the illumination device 301 is a PAR 38 LED spotlight bulb. The illumination device 301 comprises a shell 303 (shown in greater detail in FIGS. 6 and 10) having a first conical end 305 with a threaded electrical connector 307 disposed thereon, and a second parabolic end 309 which houses an electronics package 311, a synthetic jet ejector housing element 313 (shown in greater detail in FIGS. 14-16), a synthetic jet engine 315 (shown in greater detail in FIGS. 7-9) and a heat sink 317 (shown in greater detail in FIGS. 11-13).

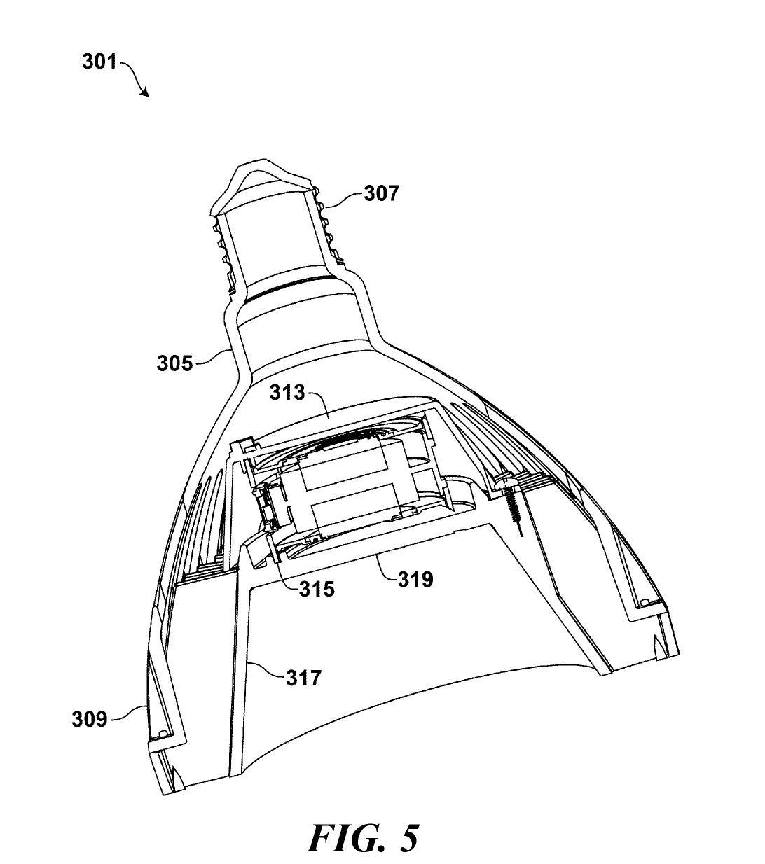

As best seen in the cross-sectional view of FIG. 5, a portion 319 of the heat sink 317, together with synthetic jet ejector housing element 313, form a housing for the synthetic jet engine 315. The resulting synthetic jet ejector thus comprises the synthetic jet engine 315 disposed within this housing. Suitable fasteners 323 (see FIG. 6) are provided to secure the synthetic jet ejector housing element 313 to the heat sink 317. As best seen in FIG. 7, a plurality of synthetic jet nozzles 325 are formed by the synthetic jet ejector housing element 313 and the heat sink 317. Though omitted for purposes of clarity, in the finished device, one or more LEDs or other light-producing elements will be disposed in the conical cavity of the heat sink 317.

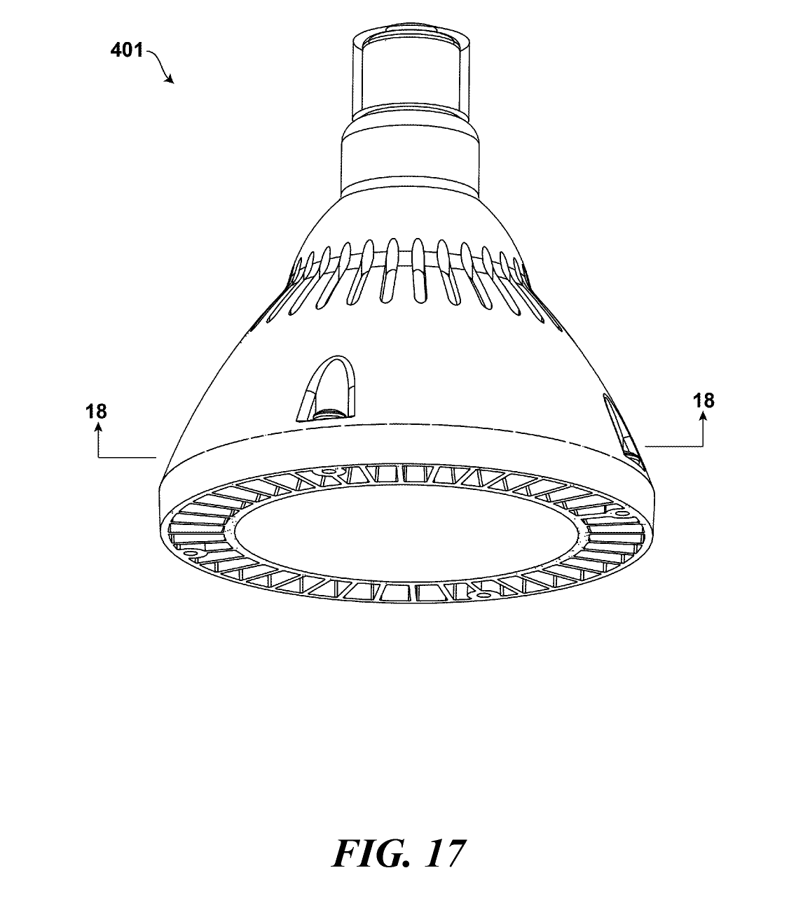

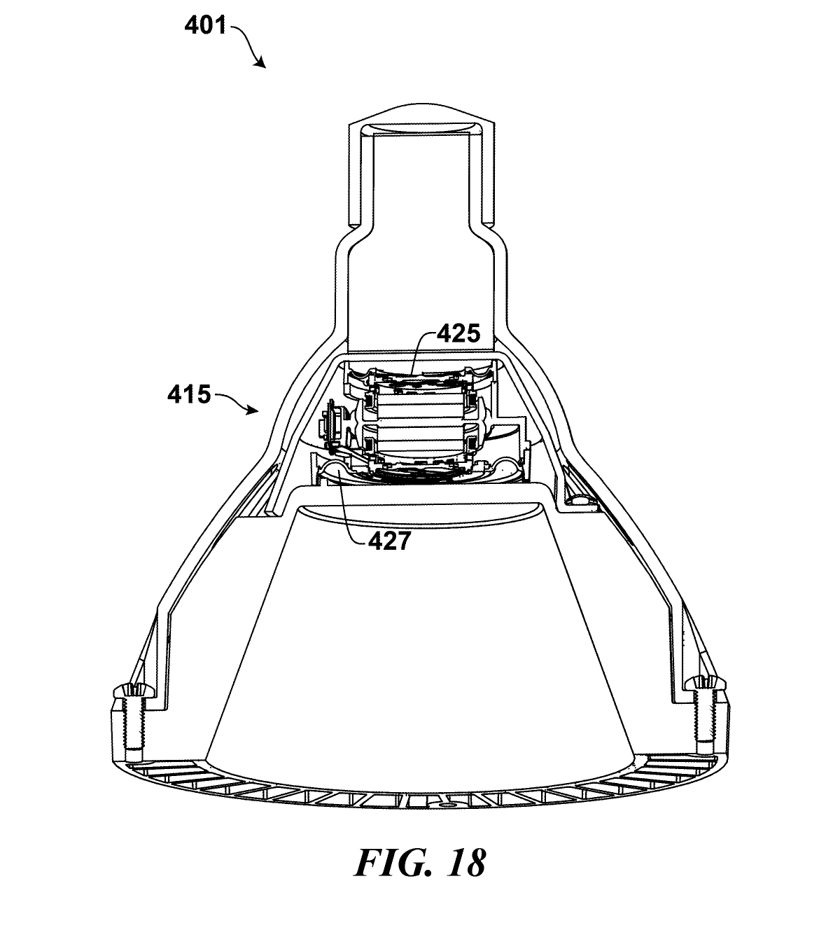

FIGS. 17-18 illustrate a second particular, non-limiting embodiment of an illumination device made in accordance with the teachings herein. The illumination device 401 of this embodiment is similar in many respects to the illumination device 301 of FIGS. 4-7, but has a slightly different profile, and is equipped with a synthetic jet engine 415 having first 425 and second 427 diaphragms of different sizes. This arrangement provides for an extra deep optics cavity. As with the embodiment of FIGS. 4-7, in this embodiment, the heat sink 417 forms one wall of the synthetic jet ejector 419.

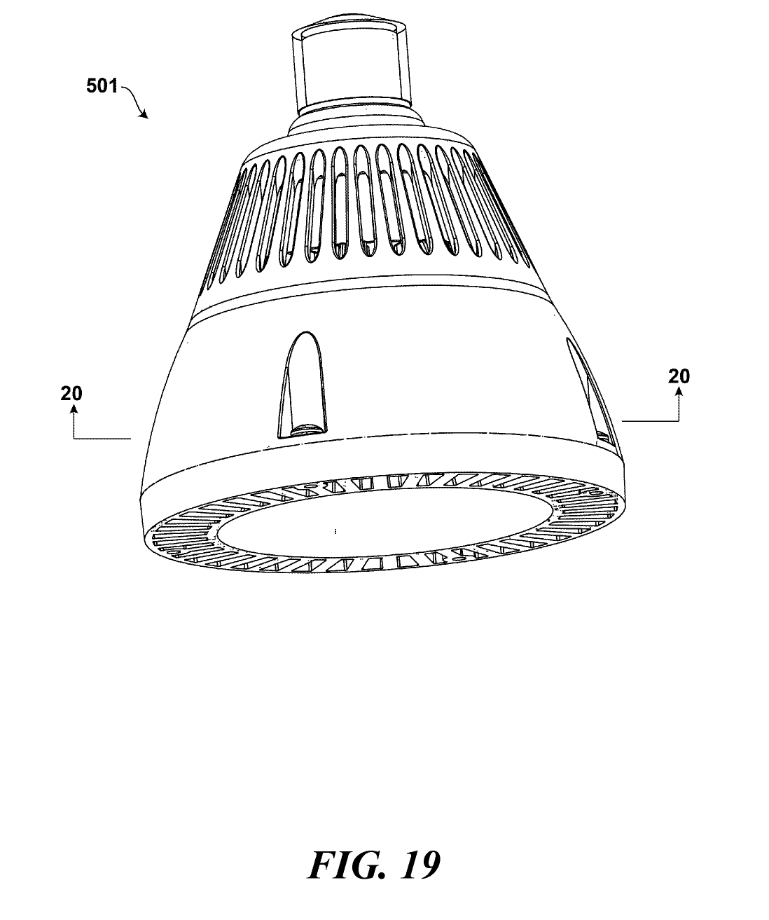

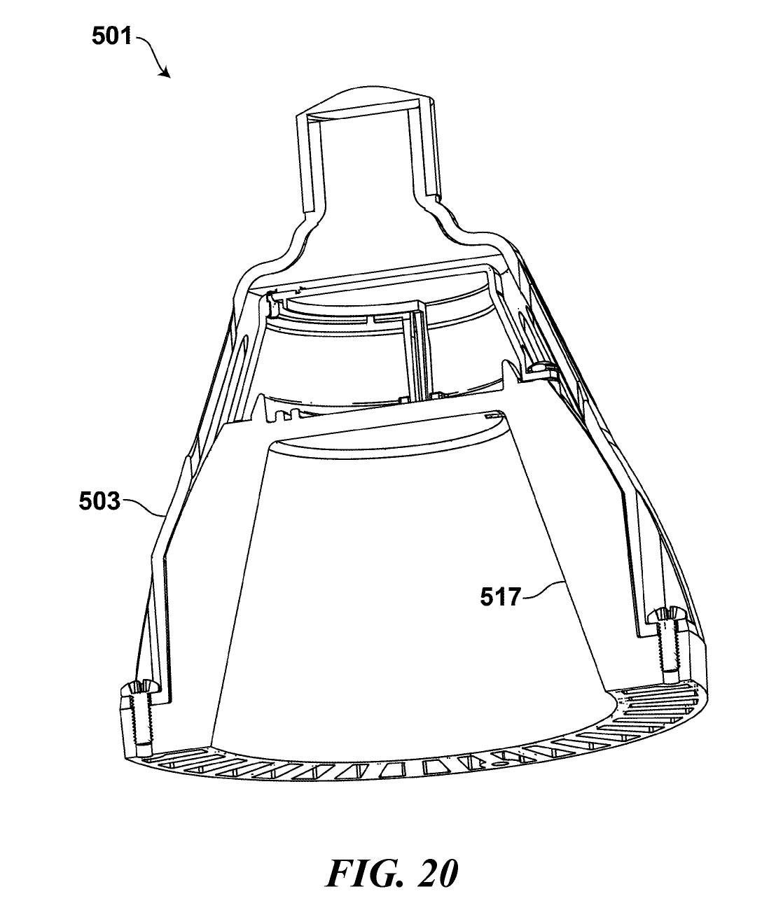

FIGS. 19-20 illustrate a third particular, non-limiting embodiment of an illumination device made in accordance with the teachings herein. The illumination device 501 of this embodiment is similar in many respects to the illumination device 301 of FIGS. 4-16, but is equipped with a different (non-standard) shell 503 having a profile which provides for an even deeper optics cavity than the device of FIGS. 17-18. As with the embodiment of FIGS. 4-16, in this embodiment, the heat sink 517 forms one wall of the synthetic jet ejector 519.

Further details of an embodiment of a synthetic jet engine which may be utilized in the foregoing embodiments may be found in U.S. Ser. No. 13/026,220 (Grimm et al.), entitled “SYNTHETIC JET EJECTOR AND DESIGN THEREOF TO FACILITATE MASS PRODUCTION”, which was filed on Feb. 12, 2011, and which is incorporated herein by reference in its entirety.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1.-22. (canceled)

23. A light source, comprising:
a housing element;
a heat sink;
a first flow channel element which, alone or in combination with said housing element, creates (a) a first set of flow paths for the flow of fluid in a first direction through the light source, and (b) a second set of flow paths for the flow of fluid in a second direction through the light source;
an LED which is in thermal contact with said heat sink; and
a synthetic jet ejector which comprises a diaphragm disposed in a chamber; wherein said chamber is in fluidic communication with said first set of flow paths, and wherein said chamber has at least one surface formed by at least one of said housing element and said heat sink.

24. The light source of claim 23, wherein said first set of flow paths is in fluidic communication with at least one surface of said heat sink.

25. The light source of claim 23, wherein said first flow channel element is disposed on a major surface of said heat sink.

26. The light source of claim 23, wherein said heat sink has a central portion with a plurality of fins extending radially therefrom, and wherein said set of LEDs is disposed on said central portion.

27. The light source of claim 26, wherein said central portion has first and second opposing surfaces, wherein said set of LEDs is disposed on said first surface, and wherein said first flow channel element is disposed on said second surface.

28. The light source of claim 26, wherein said central portion is essentially planar.

29. The light source of claim 28, wherein each of said plurality of fins is essentially planar, and wherein said plurality of fins are essentially perpendicular to the plane of said central portion.

30. The light source of claim 26, wherein said central portion is essentially circular.

31. The light source of claim 30, wherein said central portion is separated from said plurality of fins by an annular ridge.

32. The light source of claim 23, wherein said first flow channel element releasably engages said plurality of fins.

33. The light source of claim 32, wherein said first flow channel element comprises a plurality of circumferential grooves and a plurality of arcuate sections, and wherein each of said plurality of fins extends into one of said plurality of circumferential grooves.

34. The light source of claim 33, wherein any pair of adjacent circumferential grooves is separated by one of said arcuate sections.

35. The light source of claim 23, wherein said first flow channel element is disposed within said housing element.

36. The light source of claim 23, wherein said heat sink is disposed within said housing element.

37. The light source of claim 23, wherein said set of synthetic jet actuators are disposed within a second flow channel element, and wherein said second flow channel element is in fluidic communication with said first flow channel element.

38. The light source of claim 37, wherein said second flow channel element is essentially cylindrical in shape and is equipped with a plurality of spouts, and wherein said plurality of spouts are in fluidic communication with said first set of flow paths.

39. The light source of claim 38, wherein said heat sink is equipped with a plurality of fins, and wherein each of said spouts is adapted to direct a synthetic jet between an adjacent pair of fins.

40. The light source of claim 37, wherein said set of synthetic jet actuators includes first and second actuators, wherein each of said first and second actuators is equipped with an oscillating diaphragm, wherein said second flow channel element is equipped with a first set of flow channels which are in fluidic communication with the diaphragm of said first actuator, and wherein said second flow channel element is equipped with a second set of flow channels which are in fluidic communication with the diaphragm of said second actuator.

41. The light source of claim 40, wherein said first set of flow channels are disposed in a first arcuate extension which protrudes circumferentially from said second flow channel element, and wherein said second set of flow channels are disposed in a second arcuate extension which protrudes circumferentially from said second flow channel element.

42. The light source of claim 23, wherein said set of LEDs contains a plurality of LEDs arranged in an interlocking pattern.

43. The light source of claim 23, wherein said set of synthetic jet actuators is adapted to draw fluid in through said second set of flow paths, and to expel fluid through said first set of flow paths.

44. The light source of claim 43, wherein said housing element terminates in an annular lip, and wherein said second set of flow paths terminate at the periphery of said lip.

45. The light source of claim 23, wherein said set of synthetic jet actuators comprises first and second actuators disposed in opposing relationship to each other.

46. The light source of claim 23, wherein said set of actuators is disposed within said housing element and behind said heat sink.

47. The light source of claim 23, wherein said housing element has first and second ends, and further comprising an electrical contact module which is attached to said second end of said housing element by way of an adapter.

48. The light source of claim 47, wherein said adapted contains first and second annular portions, wherein said first annular portion has a smaller diameter than said second annular portion, and wherein said first and second annular portions are connected to each other by a conical portion.

49. The light source of claim 48, wherein said electrical contact module comprises a threaded metal portion which is attached to the exterior of said first annular portion.

50. The light source of claim 23, wherein said chamber has at least one surface formed by said housing element.

51. The light source of claim 23, wherein said chamber has at least one surface formed by said heat sink.

52. The light source of claim 23, wherein said chamber has at least one wall formed by said housing element.

53. The light source of claim 23, wherein said chamber has at least one wall formed by said heat sink.
